(19) United States
(12) Patent Application Publication
(10) Pub. No.: US 2005/0233625 A1
(43) Pub. Date: Oct. 20, 2005

(54) Elbow stack

(75) Inventor: Nathan H. Faulkner, Pauline, SC (US)

Correspondence Address: FOLEY & LARDNER, 777 EAST WISCONSIN AVENUE, SUITE 3800, MILWAUKEE, WI, 53202-5308, US

(73) Assignee: Siemens Energy & Automation, Inc.

(21) Appl. No.: 10/825,385

(22) Filed: Apr. 15, 2004

(51) Int. Cl. H01R 4/00

(52) U.S. Cl. 439/210

(57) ABSTRACT

An elbow stack for connecting two busway sections at an angle other than 180°. The elbow stack includes a first splice plate, at least one conductor/insulator assembly, a second splice plate, and at least one fastener. The fastener is configured to force the conductor/insulator assembly positioned between the first and second splice plates, into contact with the busway sections.

### BACKGROUND OF THE INVENTION

The present invention relates generally to an electrical power distribution busway, and more particularly to an elbow stack for making an electrical connection between two busway sections at an angle other than 180°.

Electrical power distribution busways typically include a housing, phase bus bars and a neutral bus bar. The busways can also include one or more ground bus bars. The busway section usually includes a plurality of busway sections joined together to provide an appropriate length of busway to distribute electrical power, typically in a building. To change direction of a busway system, elbow stacks are typically used for left and right directional changes as well as for up and down directional changes in the system. Conventional elbow stacks typically include a plurality of L-shaped bus bars configured in a 90° shape. Each leg of the elbow is configured with bus bar stacks which connect to other busway sections with a bus bar joint.

While the general structure of the elbow stack is known, there is a need for an elbow stack that will connection busway sections, at an angle, without the need for additional (typically 2) busway joints. There is a further need for a busway joint that is configured to reduce material and labor costs in manufacturing and erecting a busway system.

### SUMMARY OF THE INVENTION

There is provided an elbow stack for connecting two busway sections at an angle other than 180°. The elbow stack comprises a first splice plate configured to define a first bore. At least one conductor/insulator assembly configured to define a second bore. The conductor insulator assembly has a first connector end and a second connector end, wherein one end is not parallel to the other end. A second splice plate is configured to define a third bore. At least one fastener is disposed within the first, second and third bores where the fastener is configured to force the conductor/insulator assembly, positioned between the first and second splice plates, into contact with the busway sections.

There is also provided an elbow stack for connecting two busway sections each having a different longitudinal axis. The elbow stack comprises a first splice plate configured to define a first bore. At least one conductor/insulator assembly comprising, in order, a first conductor plate, a planar polygonal shaped insulator plate and a second conductor plate. Each such plate defines a part of a second bore. The conductor/insulator assembly has a first connector end and a second connector end, wherein one end is not parallel to the other end. A second splice plate is configured to define a third bore. At least one fastener is disposed within the first, second and third bores. The fastener is configured to force the conductor/insulator assembly, positioned between the first and second splice plates, into contact with the busway sections.

There is further provided an elbow stack for connecting at least two phase bus bars and a ground busbar at an angle other than 180°. The elbow stack comprises a first splice plate configured to define a first bore. At least one conductor/insulator assembly comprising, in order, a first conductor plate, a planar polygonal shaped insulator plate and a second conductor plate. Each such plate defines a part of a second bore. The conductor/insulator assembly has a first connector end and a second connector end, wherein one end is not parallel to the other end. A second splice plate is configured to define a third bore. At least one fastener is disposed within the first, second and third bores, where the fastener is configured to force the conductor/insulator assembly, positioned between the first and second splice plates, into contact with the bus bars. A grommet is mounted in the second bore, with the grommet configured with a through-bore coaxial with the second bore. An insulator sleeve is disposed on the fastener to insulate the fastener in the plurality of bores.

### BRIEF DESCRIPTION OF THE DRAWINGS

FIG. 1 is a top perspective view of an exemplary embodiment of an elbow stack.

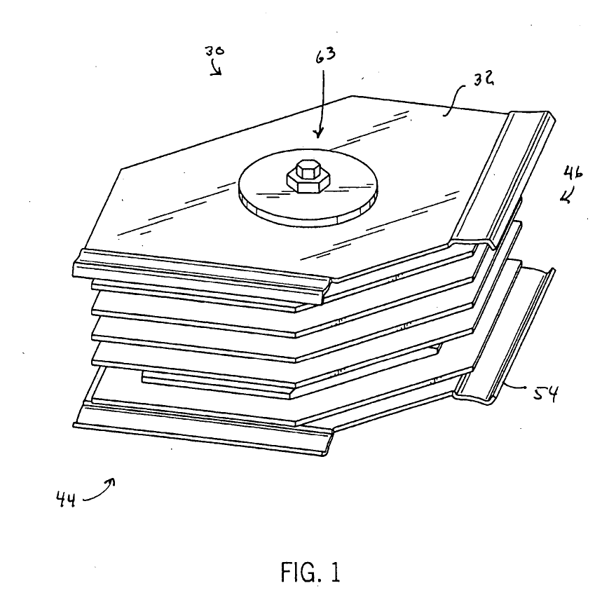

FIG. 2 is an illustration of a partial busway system including an exemplary embodiment of an elbow stack connecting two busway sections at an angle, with each busway section having a different longitudinal axis, i.e., other than 180°.

FIG. 3 is a plan view of the elbow stack illustrated in FIG. 1, is viewed normal to the second connector end.

FIG. 4 is a bottom perspective view of the elbow stack illustrated in FIG. 1.

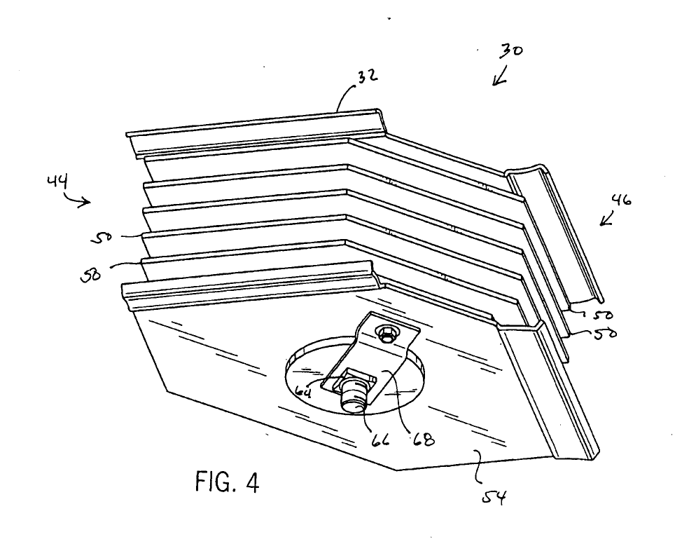

FIG. 5 is a plan view of the elbow stack illustrated in FIG. 1, as viewed normal to the first connector end.

FIG. 6 is an exploded view of an exemplary embodiment of an elbow stack for use in a busway system.

### DETAILED DESCRIPTION OF THE EXEMPLARY EMBODIMENTS

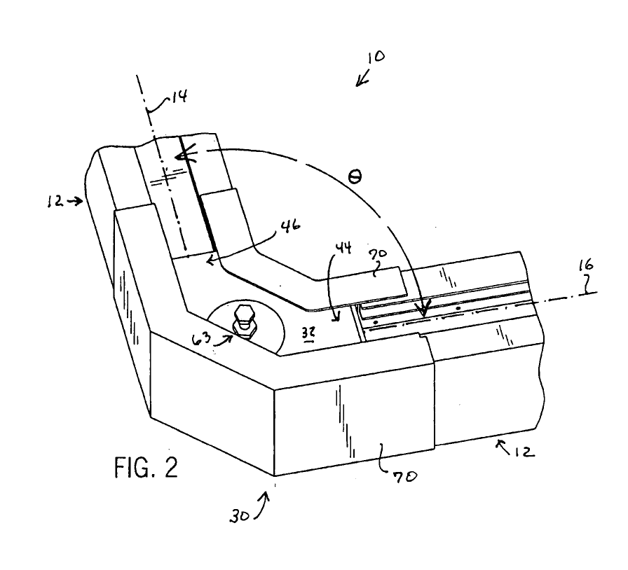

An embodiment of a busway system 10 is partially illustrated in FIG. 2. The busway system 10 conducts electrical power to a variety of locations, typically in a building or structure. The busway sections 12 can be affixed along a floor, ceiling or wall and may easily be extended to a required length by attaching additional busway sections with additional busway joints. The busway system 10 also incorporates T-sections or other split sections to direct electrical power in varying directions. Power tap-off sections provide areas of access to the electrical power in the busway so motors, electrical motor drives, power supplies, computers, printers, medical equipment, lighting, etc. may readily be connected to the electrical power source.

When the busway system 10 needs to change directions because of obstructions or routing requirements, an elbow is typically used for such direction change. Conventional elbows such as the present assignee's Sentron busway system provide an L-shaped stack of busbars at a fixed 90° angle between the elbow legs and require two joint sections to connect busway sections to the elbow. The present elbow stack 30 eliminates the need for the two joint sections and couples busway sections 12 directly to the elbow stack 30 as illustrated in FIG. 2.

The busway system 10 typically includes busbars of conductive material typically made from aluminum or copper which are coated with an insulating layer such as epoxy or other appropriate thermoset or thermoplastic material. Ground bars may also be provided within the busway system 10. Typical arrangement is to have a three-phase system with each phase consisting of one or more of phase bars 18, one or more neutral bars and one or more of ground bars 20 arranged in a busway section 12. It should be understood that busway system 10 may have fewer than three-phases. Each phase bar 18 typically will have a rectangular cross-section that is appropriate for the current carrying capacity contemplated by the busway system 10 which takes into account the ratio between the thickness of the busbar and the width of the busbar.

Referring to the figures, an elbow stack 30 for connecting two busway sections 12 at an angle θ other than 180° is illustrated. It should be understood that the angle θ between the different longitudinal axis 14, 16 of the busway sections 12 being connected by the elbow stack 30 can be set at any convenient and appropriate value as determined by the contemplated use of the busway system 10. The elbow stack 30 is fabricated to accommodate the predetermined angle θ.

The elbow stack 30 comprises a pair of splice plates 32, 54 with at least one conductor/insulator assembly 40 sandwiched between the two splice plates 32, 54. Each splice plate is configured to define a bore. The first splice plate 32 defines a first bore 34 and the second splice plate 54 defines a third bore 55. The conductor/insulator assembly 40 defines a second bore 42. At least one fastener 63 is disposed within the first, second and third bores 34, 42, 55, with the fastener configured to force the conductor/insulator assembly 40, positioned between the first and second splice plates 32, 54, into contact with the busway sections 12.

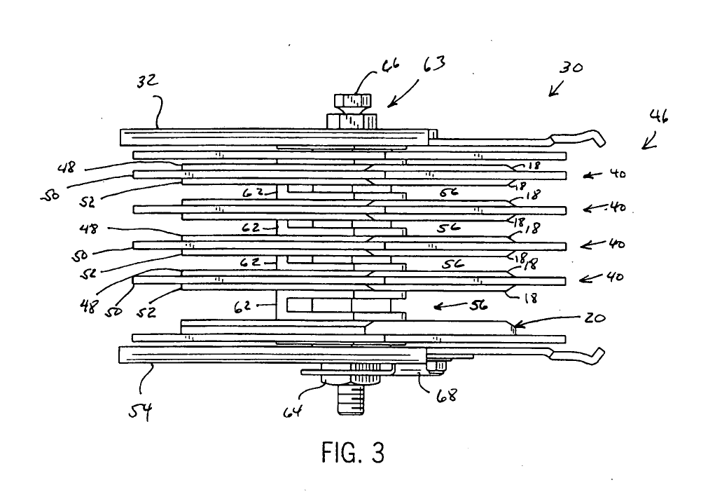

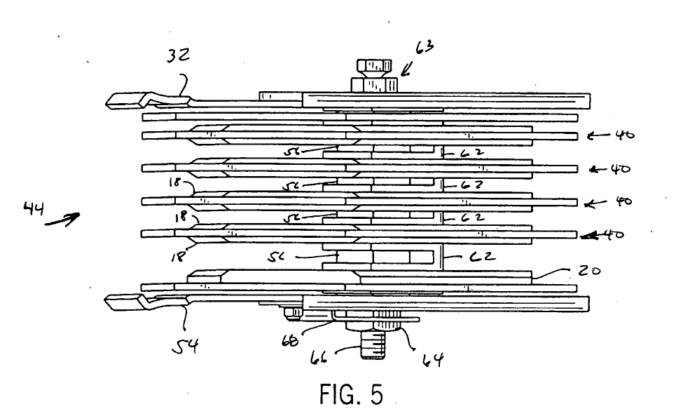

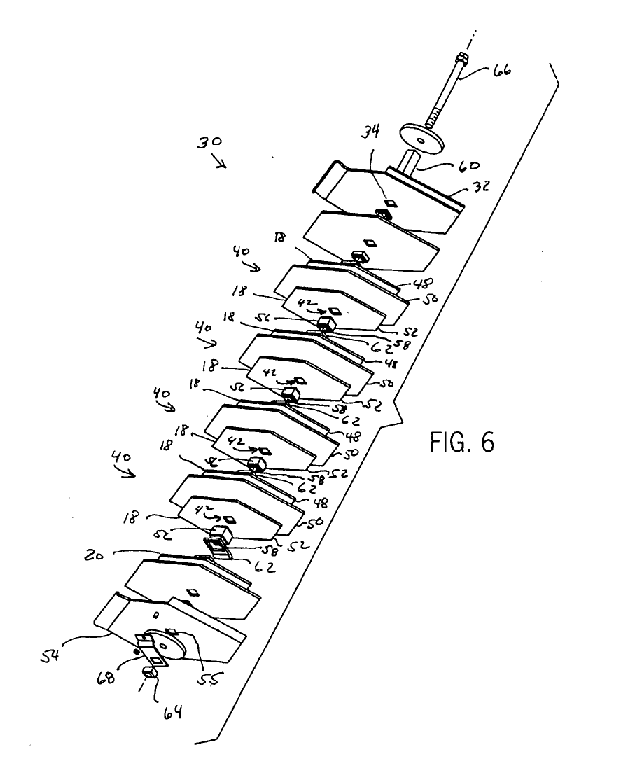

A conductor/insulator assembly 40 has a first connector end 44 and a second connector end 46, wherein one end is not parallel to the other end. It is this non-parallelism that sets the angle θ when connecting the busway sections 12 to the elbow stack 30. Each conductor/insulator assembly 40 comprises, in order, a first conductor plate 48, a planar polygonal shaped insulator plate 50 and a second conductor plate 52, with each plate defining a part of the second bore 42. The conductor plates can be copper or aluminum and the bore 42 can be machined or punched in each conductor plate. The planar polygonal shaped insulator plates 50 are referred to as insulators and typically are composed of glass-filled polyester. The insulator plate 50 typically is sized larger than the conductor plates 48, 50 as illustrated in FIGS. 3, 5 and 6. The extensions of the insulator plates 50 inhibit unintentional contact with the individual phase bars 18 which make up the conductor plates 48, 50. A grommet 56 is mounted in the second bore of the conductor/insulator assembly 40 with the grommet 56 configured with a throughbore 58 coaxial with the second bore 42.

In a typical elbow stack 30 assembly, multiple conductor/insulator assemblies 40 are positioned between the two splice plates 32, 54. The spacer 62 is positioned between each conductor/insulator assembly 40 with each spacer 62 configured to provide the appropriate spacing between phase bars 18 as well as the ground bar 20. The spacer 62 also functions to inhibit a phase bar 18 from a busway section 12 from contacting the grommet 56 or fastener 63 when assembling the busway system 10. The spacer 62 and grommet 56 can be composed of an insulating material such as neopine.

The assembly of splicer plates 32, 54 and conductor/insulator assemblies 40 are secured by a fastener 63 passing through the bores 34, 42, 55, 58. An insulator sleeve 60 is disposed on the fastener 63 to insulate the fastener 63 in the bores. The insulator sleeve 60 can be any suitable insulating material, for example, lexan. The fastener 63 can be a bolt 66 configured to pass through the entire assembly of splice plates 32, 54 and conductor/insulator assemblies 40 and secured with a nut 64. Additionally, suitable washers can be utilized with the nut 64 and bolt 66 assembly. A nut receptacle 68 is configured to accept the nut 64 and prevent rotation of the nut 64 as the fastener 63 is torqued to force the conductor/insulator assemblies 40 into contact with the busway sections 12 of the busway system 10 during the assembly of the elbow stack 30.

It should be understood that multiple fasteners 63 can be utilized in the elbow stack 30. Multiple fasteners 63 can be utilized in a high amperage elbow stack 30 configuration with appropriate first, second and third bores formed in the respective splice plates 32, 54 and conductor/insulator assemblies 40.

Installation of the elbow stack 30 is typically completed with a cover 70 configured to enclose at least a portion of the elbow stack 30. (See FIG. 2) It should be understood that the cover 70 can also be referred to as a housing that can completely enclose the elbow stack 30 and associated busway sections 12. The cover 70 housing prevents dirt and moisture from passing into the elbow stack 30. Suitable brackets can also be coupled to the elbow stack 30 to assist in mounting the elbow stack 30 in a pre-selected position.

Thus, there is provided an elbow stack for connecting two busway sections at an angle other than 180° in a busway system without the need for additional busway joints. It should be understood that the foregoing description of exemplary embodiments are examples and should not be limited to the specific forms shown. For example, the cover can be attached to the elbow stack by spot welding, rivets or screws. The connector ends may have tapered ends, full or partial arrowhead shaped cross-sections. The elbow stack and busway sections are illustrated as flatwise busway sections. It should be understood that they may also be configured as edgewise sections. The latter are typically used to create up and down directional changes in a busway system whereas the flatwise are typically used for left and right directional changes in a horizontal plane. These and other modifications may be made in the design and arrangement of the elements without departing from the scope of the invention as expressed in the appended claims.

1. An elbow stack for connecting two busway sections at an angle other than 180°, the elbow stack comprising:
a first splice plate configured to define a first bore;
at least one conductor/insulator assembly configured to define a second bore, with the assembly having a first connector end and a second connector end, wherein one end is not parallel to the other end;
a second splice plate configured to defined a third bore; and
at least one fastener disposed within the first, second and third bores, where the fastener is configured to force the conductor/insulator assembly, positioned between the first and second splice plates, into contact with the busway sections.

2. The elbow stack of claim 1, wherein the conductor/insulator assembly comprises, in order, a first conductor plate, a planar polygonal shaped insulator plate and a second conductor plate, with each plate defining a part of the second bore.

3. The elbow stack of claim 2, including a grommet mounted in the second bore, with the grommet configured with a throughbore coaxial with the second bore.

4. The elbow stack of claim 1, including an insulator sleeve disposed on the fastener to insulate the fastener in the plurality of bores.

5. The elbow stack of claim 1, including at least one additional conductor/insulator assembly positioned between the two splice plates.

6. The elbow stack of claim 5, including a spacer positioned between each conductor/insulator assembly.

7. The elbow stack of claim 1, wherein the fastener comprises a nut and bolt, with a nut receptacle configured to accept the nut and prevent rotation of the nut.

8. The elbow stack of claim 1, including a cover configured to enclose at least a portion of the elbow stack.

9. An elbow stack for connecting two busway sections each having a different longitudinal axis, the elbow stack comprising:
a first splice plate configured to define a first bore;
at least one conductor/insulator assembly comprising, in order, a first conductor plate, a planar polygonal shaped insulator plate and a second conductor plate, with each plate defining a part of a second bore, with the assembly having a first connector end and a second connector end, wherein one end is not parallel to the other end;
a second splice plate configured to define a third bore; and
at least one fastener disposed within the first, second and third bores, where the fastener is configured to force the conductor/insulator assembly, positioned between the first and second splice plates, into contact with the busway sections.

10. The elbow stack of claim 9, including a grommet mounted in the second bore, with the grommet configured with a throughbore coaxial with the second bore.

11. The elbow stack of claim 9, including an insulator sleeve disposed on the fastener to insulate the fastener in the plurality of bores.

12. The elbow stack of claim 9, including at least one additional conductor/insulator assembly positioned between the two splice plates.

13. The elbow stack of claim 12, including a spacer positioned between each conductor/insulator assembly.

14. The elbow stack of claim 9, wherein the fastener comprises a nut and bolt, with a nut receptacle configured to accept the nut and prevent rotation of the nut.

15. The elbow stack of claim 9, including a cover configured to enclose at least a portion of the elbow stack.

16. An elbow stack for connecting at least two phase busbars and a ground busbar at an angle other than 180°, the elbow stack comprising:
a first splice plate configured to define a first bore;
at least one conductor/insulator assembly comprising, in order, a first conductor plate, a planar polygonal shaped insulator plate and a second conductor plate, with each plate defining a part of a second bore, with the assembly having a first connector end and a second connector end, wherein one end is not parallel to the other end;
a second splice plate configured to define a third bore;
at least one fastener disposed within the first, second and third bores, where the fastener is configured to force the conductor/insulator assembly, positioned between the first and second splice plates, into contact with the busbars;
a grommet mounted in the second bore, with the grommet configured with a throughbore coaxial with the second bore; and
an insulator sleeve disposed on the fastener to insulate the fastener in the plurality of bores.

17. The elbow stack of claim 16, including at least one additional conductor/insulator assembly positioned between the two splice plates.

18. The elbow stack of claim 17, including a spacer positioned between each conductor/insulator assembly.

19. The elbow stack of claim 16, wherein the fastener comprises a nut and bolt, with a nut receptacle configured to accept the nut and prevent rotation of the nut.

20. The elbow stack of claim 16, including a cover configured to enclose at least a portion of the elbow stack.
